(19) United States
(12) Patent Application Publication
(10) Pub. No.: US 2026/0134013 A1
(43) Pub. Date: May 14, 2026

(54) INFERENCE ACCELERATION METHOD AND ELECTRONIC DEVICE FOR LARGE MODELS

(71) Applicant: BEIJING BAIDU NETCOM SCIENCE TECHNOLOGY CO., LTD., Beijing (CN)

(72) Inventors: Yuchen LI, Beijing (CN); Rui KONG, Beijing (CN); Han TIAN, Beijing (CN); Xinran CHEN, Beijing (CN); Qiyang LI, Beijing (CN); Hengyi CAI, Beijing (CN); Shuaiqiang WANG, Beijing (CN); Dawei YIN, Beijing (CN)

(73) Assignee: BEIJING BAIDU NETCOM SCIENCE TECHNOLOGY CO., LTD., Beijing (CN)

(21) Appl. No.: 19/443,840

(22) Filed: Jan. 8, 2026

(30) Foreign Application Priority Data
Nov. 24, 2025 (CN) 202511735319.3

(51) Int. Cl. G06F 16/3329

(52) U.S. Cl. CPC G06F 16/33295

(57) ABSTRACT

An inference acceleration method relating to artificial intelligence technical fields such as a large model, deep learning, and natural language processing is provided. The inference acceleration method for large models includes: after inputting a source text to be processed into a target large model, obtaining a top-layer hidden state of the target large model for predicting a next token; obtaining action decision information corresponding to the next token according to the top-layer hidden state; in response to determining that the action decision information is a copy action, obtaining a text copy interval corresponding to the next token according to the top-layer hidden state; copying text in the source text to be processed that is located within the text copy interval, and using a copy result as the next token.

### CROSS-REFERENCE TO RELATED APPLICATION

The present disclosure claims the priority and benefit of Chinese Patent Application No. 202511735319.3, filed on Nov. 24, 2025. The disclosure of the above application is incorporated herein by reference in its entirety.

### TECHNICAL FIELD

The present disclosure relates to the field of computer technology, and particularly to artificial intelligence technical fields such as large models, deep learning, and natural language processing. An inference acceleration method, electronic device, and readable storage medium for large models are provided.

### BACKGROUND

A large model, particularly a large language model, has become a core technology driving a development of artificial intelligence and has been widely applied in various industries. In a practical application scenario, a generation task of a large model is not entirely “creating from scratch”, but there exists a common “copying” phenomenon, i.e., a content generated by the large model includes a text fragment that can be directly copied from a source text.

However, an existing large model cannot identify these text fragments that can be “copied”, causing the large model to still adopt a token-by-token generation approach to “recreate” those text fragments that already exist in the source text. This not only causes the large model to perform a large amount of redundant computations, thereby seriously wasting valuable computational resources, but also reduces the speed when the large model performs an inference.

### SUMMARY

According to a first aspect of the present disclosure, an inference acceleration method for large models is provided, including: after inputting a source text to be processed into a target large model, obtaining a top-layer hidden state of the target large model for predicting a next token; obtaining action decision information corresponding to the next token according to the top-layer hidden state; in response to determining that the action decision information is a copy action, obtaining a text copy interval corresponding to the next token according to the top-layer hidden state; and copying a text in the source text to be processed that is located within the text copy interval, and using a copy result as the next token.

According to a second aspect of the present disclosure, an electronic device is provided, including: at least one processor; and a memory communicatively connected to the at least one processor; the memory stores instructions executable by the at least one processor to cause the at least one processor to perform the method as described above.

According to a third aspect of the present disclosure, a non-transitory computer-readable storage medium storing computer instructions is provided for causing a computer to perform the method as described above.

It should be understood that the contents described in this section is not intended to identify the key or important features of an embodiment of the present disclosure, nor is it used to limit the scope of the present disclosure. Other features of the present disclosure will become easily understood through the following description.

### BRIEF DESCRIPTION OF THE DRAWINGS

The drawings are used to better understand the present solution and do not constitute a limitation on the present disclosure. In the drawings:

FIG. 1 is a schematic diagram according to a first embodiment of the present disclosure;

FIG. 2 is a schematic diagram according to a second embodiment of the present disclosure;

FIG. 3 is a schematic diagram according to a third embodiment of the present disclosure;

FIG. 4 is a schematic diagram according to a fourth embodiment of the present disclosure;

FIG. 5 is a schematic diagram according to a fifth embodiment of the present disclosure; and

FIG. 6 is a block diagram of an electronic device for implementing an inference acceleration method for large models according to an embodiment of the present disclosure.

### DETAILED DESCRIPTION OF EMBODIMENTS

Exemplary embodiments of the present disclosure are described below with reference to the drawings, which include various details of embodiments of the present disclosure to aid understanding, and the details should be considered merely exemplary. Therefore, a person of ordinary skill in the art should recognize that various changes and modifications can be made to the embodiments described herein without departing from the scope and the spirit of the present disclosure. Similarly, for clarity and conciseness, description of well-known functions and well-known structures is omitted in the following description.

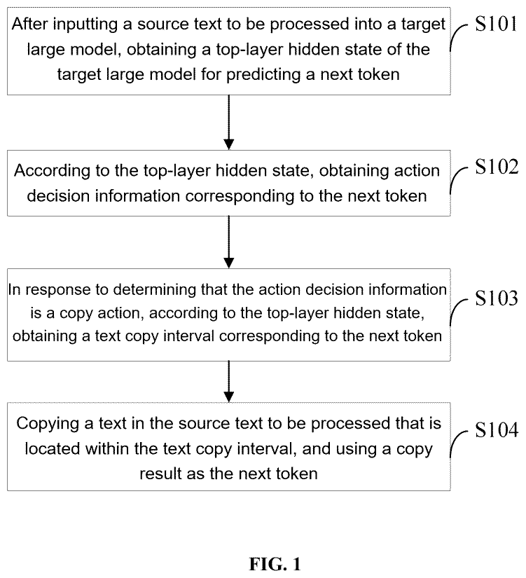

FIG. 1 is a schematic diagram according to a first embodiment of the present disclosure. As shown in FIG. 1, an inference acceleration method for large models of this embodiment specifically includes the following steps:
S101, after inputting a source text to be processed into a target large model, obtaining a top-layer hidden state of the target large model for predicting a next token;
S102, according to the top-layer hidden state, obtaining action decision information corresponding to the next token;
S103, in response to determining that the action decision information is a copy action, according to the top-layer hidden state, obtaining a text copy interval corresponding to the next token; and
S104, copying a text in the source text to be processed that is located within the text copy interval, and using a copy result as the next token.

The inference acceleration method for large models of this embodiment, before a target large model predicts a next token according to an input source text to be processed, firstly obtains action decision information corresponding to the next token according to a top-layer hidden state for predicting the next token, then in a case where the action decision information is determined to be a copy action, obtains a text copy interval corresponding to the next token according to the top-layer hidden state for predicting the next token, and finally uses a text copied from the source text to be processed corresponding to the text copy interval as the next token predicted by the target large model. This embodiment obtains the action decision information and the text copy interval according to the top-layer hidden state corresponding to the next token, enabling the target large model to obtain the next token by copying text from the source text to be processed, avoiding the computational resource waste and low inference efficiency that arise when the target large model “recreates” text already exists in the source text to be processed as the next token, and is capable of enhancing the inference speed and efficiency of the large model, and reducing redundant computations during inference, and thereby significantly saving valuable computational resources.

In this embodiment, a target large model may be a Large Language Model (LLM), and the large language model refers to a large-scale neural network model based on a deep learning technology, specifically used for processing and generating a natural language text; the target large model in this embodiment may also be a Multimodal Large Model.

In this embodiment, a token is a basic unit of a text generated through a prediction by a large model; the token may be a character, a word or a phrase, and may also be a subword (i.e., a part of a word).

In this embodiment, a Top-Layer Hidden State is a vector representation output by a decoder of the last layer (i.e., the top layer) when a target large model (for example, a large language model) processes input data, and is used for performing a prediction of a next token.

When executing S101, this embodiment firstly obtains a source text to be processed, then inputs the obtained source text to be processed into a target large model, and finally obtains a top-layer hidden state for predicting a next token output by the target large model during a process of processing the source text to be processed.

In this embodiment, the obtained source text to be processed may be a news text, a report text, etc., and the target large model is used to process the source text to be processed to obtain a summary text corresponding to the source text to be processed; in this embodiment, the obtained source text to be processed may also be a document retrieved according to a question-answer text, for example, a financial report document, a knowledge document, etc., and the target large model is used to process the source text to be processed to obtain an answer text corresponding to the question-answer text; in this embodiment, the obtained source text to be processed may also be a structured data corresponding to a field such as a sports event, a weather forecast, a medical record, etc., and the target large model is used to process the source text to be processed to obtain a report text corresponding to the source text to be processed; in this embodiment, the obtained source text to be processed may also be a code to be completed, and the target large model is used to process the source text to be processed to obtain a complete code corresponding to the source text to be processed.

When executing S101, for a first token predicted by the target large model, the top-layer hidden state for predicting the token is obtained by the target large model according to the source text to be processed; for a non-first token predicted by the target large model, the top-layer hidden state for predicting the token is obtained by the target large model according to the source text to be processed and an already predicted token(s).

After executing S101 to obtain the top-layer hidden state of the target large model for predicting the next token, this embodiment executes S102 to obtain action decision information corresponding to the next token according to the obtained top-layer hidden state.

In prior art, after the large model obtains the top-layer hidden state for predicting the next token, the top-layer hidden state is usually directly input into a Language Model Head (LM Head) of the large model, so that the language model head generates corresponding content according to the top-layer hidden state, thereby completing the prediction of the next token.

However, in a practical application scenario, a generation task of a large model is not entirely “creating from scratch”, but there exists a common “copying” phenomenon, i.e., the generated content of the large model includes a large amount of text fragments that can be directly copied from the source text to be processed (for example, context, dialogue histories, etc.); if these text fragments that can be “copied” cannot be identified, the large model will “recreate” these text fragments that already exist in the source text to be processed, thereby causing a large amount of redundant computations, seriously wasting valuable computational resources, and not fully utilizing contextual information, etc. to improve the token generation efficiency.

Therefore, to avoid redundant computations and improve token generation efficiency, after obtaining the top-layer hidden state of the target large model for predicting the next token, this embodiment executes S102 to obtain action decision information corresponding to the next token according to the top-layer hidden state.

The action decision information obtained by executing S102 in this embodiment is one of a copy action or a generation action. The copy action is used to indicate that the target large model obtains a prediction result of the next token through a “copy” operation, and the generation action is used to indicate that the target large model obtains a prediction result of the next token through a “generation” operation.

Specifically, when executing S102 to obtain action decision information corresponding to the next token according to the top-layer hidden state, an implementation manner that may be adopted in this embodiment is: inputting the obtained top-layer hidden state into a decision prediction head of the target large model, i.e., the target large model of this embodiment includes the decision prediction head for obtaining the action decision information; according to an output result of the decision prediction head, obtaining the action decision information corresponding to the next token.

That is to say, this embodiment obtains action decision information corresponding to the next token through the decision prediction head included in the target large model, and the decision prediction head is obtained through pre-training and is capable of outputting corresponding action decision information according to the input top-layer hidden state, therefore this embodiment uses the decision prediction head located in the target large model, and is capable of improving efficiency and accuracy of obtaining the action decision information.

After executing S102 to obtain the action decision information corresponding to the next token, this embodiment executes S103 to, in response to determining that the action decision information is a copy action, obtain a text copy interval corresponding to the next token according to the top-layer hidden state.

Specifically, when executing S103 to obtain the text copy interval corresponding to the next token according to the top-layer hidden state, an implementation manner that may be adopted in this embodiment is: inputting the obtained top-layer hidden state into a start point prediction head of the target large model, and according to an output result of the start point prediction head, obtaining a copy start position corresponding to the next token, i.e., the target large model of this embodiment includes the start point prediction head for obtaining the copy start position; inputting the obtained top-layer hidden state into an end point prediction head of the target large model, and according to an output result of the end point prediction head, obtaining a copy end position corresponding to the next token, i.e., the target large model of this embodiment includes the end point prediction head for obtaining the copy end position; according to the obtained copy start position and the copy end position, obtaining the text copy interval corresponding to the next token.

That is to say, this embodiment obtains the text copy interval corresponding to the next token through the start point prediction head and the end point prediction head included in the target large model, and the start point prediction head and the end point prediction head are obtained through pre-training and are capable of respectively outputting the copy start position and the copy end position according to the input top-layer hidden state, therefore this embodiment uses the start point prediction head and the end point prediction head located in the target large model, and is capable of improving the efficiency and accuracy of obtaining the text copy interval.

In addition, when executing S103, this embodiment may also include the following content: in response to determining that the action decision information is a generation action, inputting the obtained top-layer hidden state into a language model head of the target large model; according to an output result of the language model head, obtaining the next token.

That is to say, after determining that the obtained action decision information is a generation action, this embodiment uses an existing token generation manner, i.e., the language model head generates the next token in real time according to the top-layer hidden state corresponding to the next token.

Therefore, this embodiment, according to the obtained action decision information corresponding to the next token, determines whether an obtaining manner of the next token is “copying” or “generating”, effectively avoiding the drawbacks of exclusively using the generation manner to obtain the next token, and is capable of improving the flexibility and efficiency of obtaining the next token.

After executing S103 to obtain the text copy interval corresponding to the next token, this embodiment executes S104 to copy the text in the source text to be processed that is located within the text copy interval, and use the copy result as the next token.

That is to say, after executing S103 to obtain the text copy interval corresponding to the next token, this embodiment can copy the specific text content in the source text to be processed according to the obtained text copy interval, thereby using the copy result as the next token to be predicted by the target large model. Since the text copying has a faster obtaining speed and requires no redundant computations compared with the text generation, this embodiment can greatly improve an inference speed of the target large model and effectively save computational resources required when the target large model performs inference.

It can be understood that, after obtaining the source text to be processed, the target large model in this embodiment may use a tokenizer to convert the source text to be processed into a subword sequence, and the converted subword sequence includes a plurality of subwords and position information of each subword.

Therefore, when executing S104 to copy the text in the source text to be processed that is located within the text copy interval and use the copy result as the next token, an implementation manner that may be adopted in this embodiment is: obtaining the subword sequence of the source text to be processed; according to the position information of each subword in the subword sequence, determining a subword in the subword sequence that is located within the text copy interval; copying the determined subword, and using the copy result as the next token.

That is to say, this embodiment copies the specific text content in the source text to be processed according to an obtained text copy interval, and uses the copy result as the next token to be predicted by the target large model, without requiring the target large model to predict the next token through a generation manner, effectively improving the inference speed of the target large model (i.e., the speed of predicting the next token), and through a manner of obtaining the next token by copying from the source text to be processed, is also capable of avoiding a “hallucination” problem of the large model, thereby improving the accuracy of an obtained token.

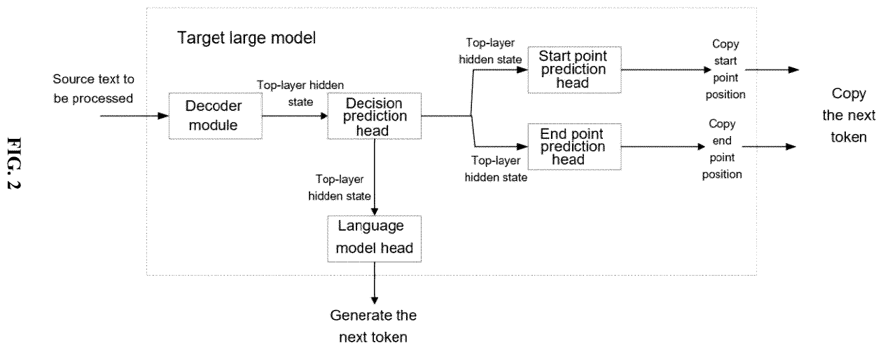

FIG. 2 is a schematic diagram according to a second embodiment of the present disclosure. As shown in FIG. 2, this embodiment shows a structural diagram of a target large model. In this embodiment, the target large model is a span pointer large model (SpanPointerLlama) extended based on a standard large language model (for example, an open-source large language model such as Llama).

The target large model in this embodiment includes a decoder module (including a plurality of decoder blocks), a language model head, a decision prediction head, a start point prediction head, and an end point prediction head; and a top-layer hidden state is a hidden state output by the last decoder block in the decoder module.

After inputting a source text to be processed into the target large model, this embodiment obtains a top-layer hidden state of the target large model for predicting a next token through the decoder module; inputs the obtained top-layer hidden state into the decision prediction head to obtain the action decision information output by the decision prediction head; if the action decision information is a copy action, inputs the top-layer hidden state into the start point prediction head and the end point prediction head, and then obtains the next token by copying from a text to be processed according to a copy start position and a copy end position respectively output by the start point prediction head and the end point prediction head; if the action decision information is a generation action, inputs the top-layer hidden state into the language model head, and then the language model head generates the next token according to the top-layer hidden state; after completing the prediction of the next token, a subsequent token is predicted according to the above steps.

The target large model provided in this embodiment can be applied to a summary generation system, a retrieval-enhanced question-answering system, a data-driven text generation system, a code generation and completion system, etc.

For example, when generating a news summary, the prior art may incorrectly quote a person name, a place name, a company name or other key data; by using a target large model provided in this embodiment, the decision prediction head identifies that this entity information and data are key content that needs precise repetition, thereby activating a “copy” mode, and directly locating and completely copying from the original text through the “start point/end point prediction head”; for a connecting sentence or a paragraph that needs to be generalized, the model switches back to a “generation” mode to produce a fluent text, thereby making a generated summary not only highly readable but also absolutely accurate in a factual information.

For example, when answering a query input by a user in prior art, a retrieval-enhanced generation system first retrieves a document related to the query, and a traditional generation model may reorganize an answer using the traditional generation model's own language after reading these documents, thereby introducing a bias; after using a target large model provided in this embodiment, a most core sentence can be directly extracted from a retrieved document through a “copy” mode to construct a complete answer, greatly improving the reliability of a question-answering system when handling a structured, data-intensive problem.

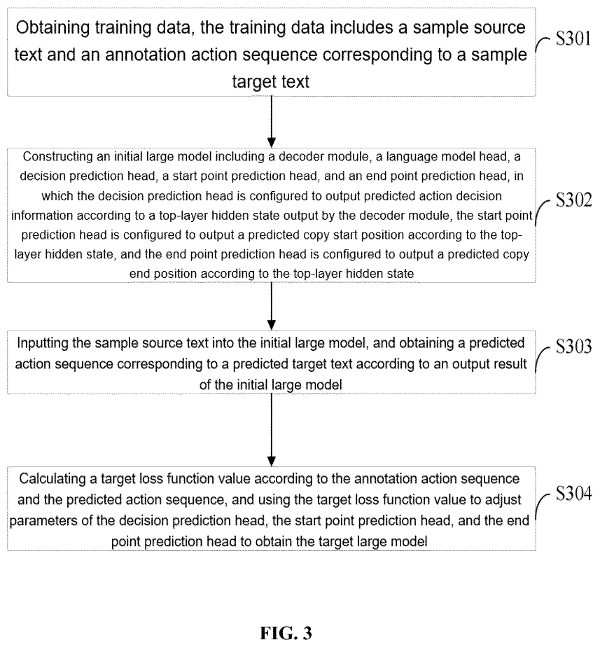

FIG. 3 is a schematic diagram according to a third embodiment of the present disclosure. As shown in FIG. 3, this embodiment shows a training process of a target large model, specifically including the following steps:
S301, obtaining training data, the training data includes a sample source text and an annotation action sequence corresponding to a sample target text;
S302, constructing an initial large model including a decoder module, a language model head, a decision prediction head, a start point prediction head, and an end point prediction head, in which the decision prediction head is configured to output predicted action decision information according to a top-layer hidden state output by the decoder module, the start point prediction head is configured to output a predicted copy start position according to the top-layer hidden state, and the end point prediction head is configured to output a predicted copy end position according to the top-layer hidden state;
S303, inputting the sample source text into the initial large model, and obtaining a predicted action sequence corresponding to a predicted target text according to an output result of the initial large model;
S304, calculating a target loss function value according to the annotation action sequence and the predicted action sequence, and using the target loss function value to adjust parameters of the decision prediction head, the start point prediction head, and the end point prediction head to obtain the target large model.

That is to say, this embodiment obtains an initial large model by additionally adding a decision prediction head, a start point prediction head, and an end point prediction head based on an existing large model, and then adjusts parameters of three newly added prediction heads in the initial large model according to an annotation action sequence and a predicted action sequence obtained by the initial large model based on a sample source text, thereby obtaining a target large model. Since this embodiment additionally adds the three prediction heads in the large model, this embodiment integrates two operations of “generation” and “copying” within a unified, end-to-end trainable neural network framework, enabling a rapid adaptation to any existing large model with an extremely low computational cost.

In the training data obtained by executing S301 in this embodiment, the sample target text corresponding to the annotation action sequence is the target text corresponding to the sample source text, for example, if the sample source text is a news article, then the sample target text is a summary corresponding to the news article.

In this embodiment, the annotation action sequence in the training data includes a plurality of annotation actions, and each annotation action includes annotation action decision information, an annotation copy start position, and an annotation copy end position, and a different annotation action corresponds to a different token (for example, a subword) in the sample target text.

For example, if the sample target text includes token1, token2, token3, and token4, then an annotation action sequence corresponding to the sample target text includes an annotation action corresponding to token1, an annotation action corresponding to token2, an annotation action corresponding to token3, and an annotation action corresponding to token4; the annotation action corresponding to token1 may be (“copy”, istart, iend), “copy” indicates that the annotation action decision information of token1 is a copy, and istart and iend are respectively an annotation start position and an annotation end position of token1 in the sample source text; the annotation action corresponding to token2 may be (“generate”, null), “generate” indicates that the annotation action decision information of token2 is a generation, and “null” indicates that token2 is not located in the sample source text.

After executing S301 to obtain the training data, this embodiment executes S302 to construct the initial large model including the decoder module, the language model head, the decision prediction head, the start point prediction head, and the end point prediction head.

In this embodiment, the decoder module is configured to obtain the top-layer hidden state used when predicting each token; the decoder module includes a plurality of decoder blocks, and the top-layer hidden state is a hidden state output by the last decoder block in the decoder module.

In this embodiment, the decision prediction head is configured to output predicted action decision information corresponding to predicting each token according to the top-layer hidden state output by the decoder module each time, and the predicted action decision information includes one of a copy action or a generation action.

Specifically, when outputting the predicted action decision information according to the top-layer hidden state, the decision prediction head in this embodiment may first perform a linear transformation on the top-layer hidden state to obtain a two-dimensional vector (for example, a logits_{gate}), then obtain a copy action probability and a generation action probability according to the obtained two-dimensional vector, and finally obtain the predicted action decision information according to the obtained two probabilities (for example, use an action with a larger probability as the predicted action decision information).

In this embodiment, the start point prediction head is activated when the predicted action information output by the decision prediction head is a “copy action”, and is configured to output the predicted copy start position according to the top-layer hidden state output by the decoder module, and the predicted start position is used to indicate the start position when copying a corresponding token from the sample source text.

Specifically, when outputting the predicted copy start position according to the top-layer hidden state, the start point prediction head in this embodiment may first perform a linear transformation on the top-layer hidden state to obtain a two-dimensional vector (for example, a logitsₛₜₐᵣₜ), then obtain a probability distribution over positions in the sample source text serving as a start position of a corresponding token according to the obtained two-dimensional vector, and finally obtain the predicted copy start position according to the obtained probability distribution (for example, use a start position with a maximum probability as the predicted copy start position).

In this embodiment, an end point prediction head is activated when the predicted action information output by the decision prediction head is a “copy action”, and is configured to output a predicted copy end position according to the top-layer hidden state output by the decoder module, and the predicted end position is used to indicate an end position when copying a corresponding token from the sample source text.

Specifically, when outputting the predicted copy end position according to the top-layer hidden state, the end point prediction head in this embodiment may first perform a linear transformation on the top-layer hidden state to obtain a two-dimensional vector (for example, a logits_{end}), then obtain a probability distribution over positions in the sample source text serving as the end position of a corresponding token according to the obtained two-dimensional vector, and finally obtain the predicted copy end position according to the obtained probability distribution (for example, use an end position with a maximum probability as a predicted copy start position).

In this embodiment, the language model head is activated when the predicted action information output by the decision prediction head is a “generation action”, and is configured to generate a corresponding token according to the top-layer hidden state output by the decoder module.

After executing S302 to complete construction of the initial large model, this embodiment executes S303 to input the sample source text into the initial large model, and obtain a predicted action sequence corresponding to a predicted target text according to an output result of the initial large model.

In this embodiment, the predicted action sequence obtained according to the output result of the initial large model includes a plurality of predicted actions, and each predicted action includes predicted action decision information output by the decision prediction head, the predicted copy start position output by the start point prediction head, and the predicted copy end position output by the end point prediction head, and a different predicted action corresponds to a different token (for example, a subword) in the predicted target text.

In this embodiment, the predicted target text is a target text generated by the initial large model according to the input sample source text; since the initial large model in this embodiment does not modify the decoder module and the language model head, the predicted target text output by the initial large model is consistent with the sample target text corresponding to the sample source text.

After executing S303 to obtain the predicted action sequence corresponding to the predicted target text, this embodiment executes S304 to calculate the target loss function value according to the annotation action sequence and the predicted action sequence, and use the target loss function value to adjust parameters of the decision prediction head, the start point prediction head, and the end point prediction head to obtain the target large model.

Specifically, when executing S304 to calculate the target loss function value according to the annotation action sequence and the predicted action sequence, an implementation manner that may be adopted in this embodiment is: according to the annotation action decision information and the predicted action decision information corresponding to a same token in the action sequence, calculating a first loss function value, and the first loss function value is used to supervise the decision prediction head; according to the annotation copy start position and the predicted copy start position corresponding to the same token in the action sequence, calculating a second loss function value, and the second loss function value is used to supervise the start point prediction head; according to the annotation copy end position and the predicted copy end position corresponding to the same token in the action sequence, calculating a third loss function value; according to the obtained first loss function value, the second loss function value, and the third loss function value, obtaining the target loss function value, for example, using a sum result of the three loss function values as the target loss function value.

That is to say, this embodiment obtains the target loss function value for adjusting three prediction heads according to the action decision information, the copy start position, and the copy end position included in the action sequence, and is capable of improving the accuracy of the obtained target loss function value, and thereby improving the accuracy when adjusting parameters of the three prediction heads.

In addition, when executing S304, this embodiment may also adopt a LoRA (Low-Rank Adaptation) method to fine-tune the initial large model, i.e., freezing main parameters of the initial large model and only training three newly added prediction heads and an introduced low-rank decomposition matrix, and is capable of significantly reducing computational resources and storage costs required for fine-tuning the large model, enabling the initial large model to be trained on a consumer-grade hardware and easily applied to large language models of different scales.

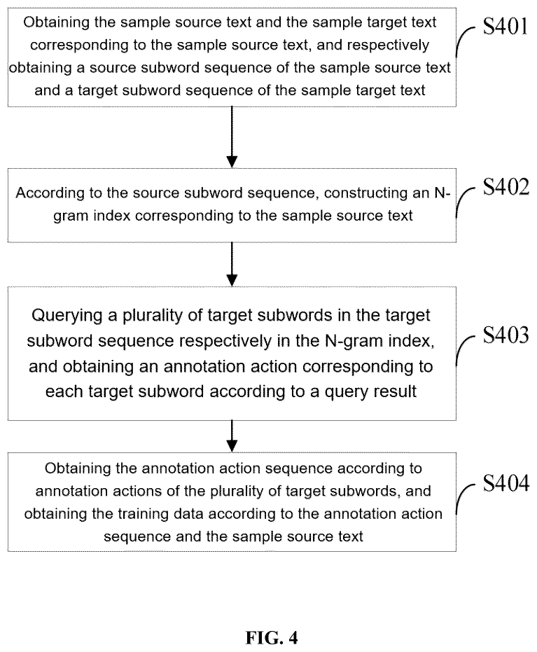

FIG. 4 is a schematic diagram according to a fourth embodiment of the present disclosure. As shown in FIG. 4, this embodiment shows a process of obtaining training data, specifically including the following steps:
S401, obtaining the sample source text and the sample target text corresponding to the sample source text, and respectively obtaining a source subword sequence of the sample source text and a target subword sequence of the sample target text;
S402, according to the source subword sequence, constructing an N-gram index corresponding to the sample source text;
S403, querying a plurality of target subwords in the target subword sequence respectively in the N-gram index, and obtaining an annotation action corresponding to each target subword according to a query result;
S404, obtaining the annotation action sequence according to annotation actions of the plurality of target subwords, and obtaining the training data according to the annotation action sequence and the sample source text.

That is to say, this embodiment uses an existing text pair (i.e., including the source text and its corresponding target text) to perform automatic obtaining of the training data, and can automatically obtain the annotation action sequence as the training data without any manual annotation cost, improving the efficiency and reducing the cost of obtaining the training data.

When executing S401, this embodiment may use a preset tokenizer (for example, a tokenizer corresponding to the target large model) to convert the sample source text into the source subword sequence and convert the sample target text into the target subword sequence; for example, the source subword sequence may be Sₜₒₖ={S₁, S₂, . . . S_{M}}, and the target subword sequence may be Tₜₒₖ={T₁, T₂, . . . T_{N}}, where M and N are respectively a subword length of a source text (S) and a target text (T).

An N-gram index corresponding to the sample source text constructed by executing S402 in this embodiment includes a plurality of source subword fragments and a start position and an end position of each source subword fragment in the sample source text.

In this embodiment, each source subword fragment in an N-gram index is composed of N consecutive source subwords; it can be understood that each source subword fragment in this embodiment may also be composed of more than N consecutive source subwords.

When executing S403 to query the plurality of target subwords in the target subword sequence respectively in an N-gram index and obtain the annotation action corresponding to each target subword according to the query result, an implementation manner that may be adopted in this embodiment is: according to a current target subword, querying in the N-gram index; in response to determining that a target source subword fragment matching the current target subword is found in the N-gram index, using a copy action as annotation action decision information of the current target subword, using a start position of the target source subword fragment in the sample source text as an annotation copy start position of the current target subword, and using an end position of the target source subword fragment in the sample source text as an annotation copy end position of the current target subword.

When executing S403, this embodiment may also include the following content:
in response to determining that no target source subword fragment matching the current target subword is found in the N-gram index, using a generation action as the annotation action decision information of the current target subword.

That is to say, this embodiment sequentially queries the target subwords in the target subword sequence in the constructed N-gram index, obtains the annotation action corresponding to each target subword in the target subword sequence according to an obtained query result, and then obtains the annotation action sequence for model training according to the obtained annotation action, and is capable of improving obtaining efficiency of the annotation action sequence and reducing obtaining cost of the annotation action sequence.

In addition, when executing S403, this embodiment may, according to a target subword fragment formed by the current target subword and N−1 target subwords located after the current target subword, query in the N-gram index, and if there exists a target source subword fragment corresponding to the target subword fragment, then obtain the annotation action of the current target subword according to a “copy action” and position information corresponding to the target source subword fragment, and then perform next query after moving forward N units in the target subword sequence.

When executing S403, if a target source subword fragment corresponding to the target subword fragment is not able to be found in the N-gram index, then the process moves forward 1 unit in the target subword sequence and continues to query a target subword located after the current target subword.

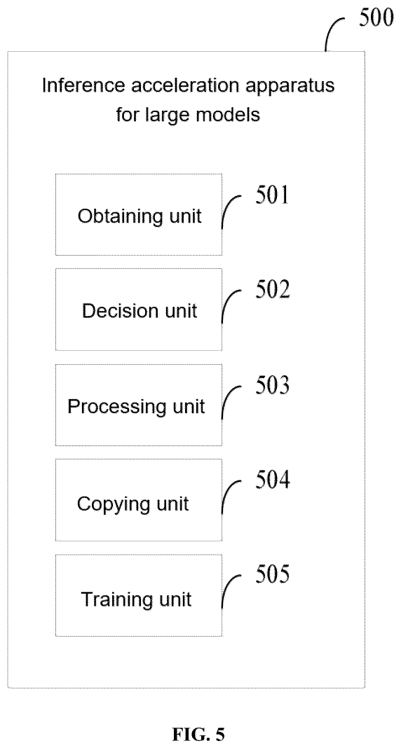

FIG. 5 is a schematic diagram according to a fifth embodiment of the present disclosure. As shown in FIG. 5, an inference acceleration apparatus 500 for large models of this embodiment includes:
an obtaining unit 501, configured to, after a source text to be processed is input into a target large model, obtain a top-layer hidden state of the target large model for predicting a next token;
a decision unit 502, configured to obtain action decision information corresponding to the next token according to the top-layer hidden state;
a processing unit 503, configured to, in response to determining that the action decision information is a copy action, obtain a text copy interval corresponding to the next token according to the top-layer hidden state; and
a copying unit 504, configured to copy a text in the source text to be processed that is located within the text copy interval, and use a copy result as the next token.

The obtaining unit 501 may firstly obtain a source text to be processed, then input the obtained source text to be processed into a target large model, and finally obtain a top-layer hidden state for predicting a next token output by the target large model during a process of processing the source text to be processed.

For a first token predicted by the target large model, the top-layer hidden state for predicting the token obtained by the obtaining unit 501 is obtained by the target large model according to the source text to be processed; for a non-first token predicted by the target large model, the top-layer hidden state for predicting the token obtained by the obtaining unit 501 is obtained by the target large model according to the source text to be processed and an already predicted token(s).

After the obtaining unit 501 obtains the top-layer hidden state of the target large model for predicting the next token, the decision unit 502 obtains action decision information corresponding to the next token according to the obtained top-layer hidden state.

To avoid redundant computations and improve token generation efficiency, after obtaining the top-layer hidden state of the target large model for predicting the next token, the decision unit 502 obtains action decision information corresponding to the next token according to the top-layer hidden state.

The action decision information obtained by the decision unit 502 is one of a copy action or a generation action; The copy action is used to indicate that the target large model obtains the prediction result of the next token through a “copy” operation, and the generation action is used to indicate that the target large model obtains the prediction result of the next token through a “generation” operation.

Specifically, when the decision unit 502 obtains action decision information corresponding to the next token according to the top-layer hidden state, an implementation manner that may be adopted is: inputting the obtained top-layer hidden state into the decision prediction head of the target large model, i.e., the target large model of this embodiment includes the decision prediction head for obtaining the action decision information; according to an output result of the decision prediction head, obtaining the action decision information corresponding to the next token.

That is to say, the decision unit 502 obtains action decision information corresponding to the next token through the decision prediction head included in the target large model, and the decision prediction head is obtained through pre-training and is capable of outputting corresponding action decision information according to an input top-layer hidden state, therefore this embodiment uses the decision prediction head located in the target large model, and is capable of improving efficiency and accuracy of obtaining the action decision information.

After the decision unit 502 obtains action decision information corresponding to the next token, the processing unit 503, in response to determining that the action decision information is a copy action, obtains a text copy interval corresponding to the next token according to the top-layer hidden state.

Specifically, when the processing unit 503 obtains the text copy interval corresponding to the next token according to the top-layer hidden state, an implementation manner that may be adopted is: inputting the obtained top-layer hidden state into a start point prediction head of the target large model, and according to an output result of the start point prediction head, obtaining a copy start position corresponding to the next token, i.e., the target large model of this embodiment includes the start point prediction head for obtaining the copy start position; inputting the obtained top-layer hidden state into an end point prediction head of the target large model, and according to an output result of the end point prediction head, obtaining a copy end position corresponding to the next token, i.e., the target large model of this embodiment includes the end point prediction head for obtaining the copy end position; according to the obtained copy start position and the copy end position, obtaining the text copy interval corresponding to the next token.

That is to say, the processing unit 503 obtains the text copy interval corresponding to the next token through the start point prediction head and the end point prediction head included in the target large model, and the start point prediction head and the end point prediction head are obtained through pre-training and are capable of respectively outputting the copy start position and the copy end position according to an input top-layer hidden state, therefore this embodiment uses the start point prediction head and the end point prediction head located in the target large model, and is capable of improving the efficiency and accuracy of obtaining the text copy interval.

In addition, the processing unit 503 may also execute the following content: in response to determining that action decision information is a generation action, inputting an obtained top-layer hidden state into a language model head of the target large model; according to an output result of the language model head, obtaining the next token.

That is to say, after determining that the obtained action decision information is a generation action, the processing unit 503 uses an existing token generation manner, i.e., the language model head generates the next token in real time according to a top-layer hidden state corresponding to the next token.

Therefore, this embodiment, according to the obtained action decision information corresponding to the next token, determines whether an obtaining manner of the next token is “copying” or “generating”, effectively avoiding the drawbacks of exclusively using the generation manner to obtain the next token, and is capable of improving the flexibility and efficiency of obtaining the next token.

After the processing unit 503 obtains the text copy interval corresponding to the next token, the copying unit 504 copies the text in the source text to be processed that is located within the text copy interval, and uses the copy result as the next token.

That is to say, after the processing unit 503 obtains the text copy interval corresponding to the next token, the copying unit 504 can copy the specific text content in the source text to be processed according to the obtained text copy interval, thereby using the copy result as the next token to be predicted by the target large model. Since the text copying has a faster obtaining speed and requires no redundant computations compared with the text generation, this embodiment can greatly improve an inference speed of the target large model and effectively save computational resources required when the target large model performs inference.

It can be understood that, after obtaining the source text to be processed, the target large model in this embodiment may use a tokenizer to convert the source text to be processed into a subword sequence, and the converted subword sequence includes a plurality of subwords and position information of each subword.

Therefore, when the copying unit 504 copies the text in the source text to be processed that is located within the text copy interval and uses the copy result as the next token, an implementation manner that may be adopted is: obtaining the subword sequence of the source text to be processed; according to the position information of each subword in the subword sequence, determining a subword in the subword sequence that is located within the text copy interval; copying the determined subword, and using the copy result as the next token.

That is to say, the copying unit 504 copies the specific text content in the source text to be processed according to an obtained text copy interval, and uses the copy result as the next token to be predicted by the target large model, without requiring the target large model to predict the next token through a generation manner, effectively improving the inference speed of the target large model (i.e., the speed of predicting the next token), and through a manner of obtaining the next token by copying from the source text to be processed, is also capable of avoiding a “hallucination” problem of the large model, thereby improving the accuracy of an obtained token.

An inference acceleration apparatus 500 for large models of this embodiment may also include a training unit 505, configured to train to obtain the target large model in the following manner: obtaining training data, the training data includes a sample source text and an annotation action sequence corresponding to a sample target text; constructing an initial large model including a decoder module, a language model head, a decision prediction head, a start point prediction head, and an end point prediction head, in which the decision prediction head is configured to output predicted action decision information according to a top-layer hidden state output by the decoder module, the start point prediction head is configured to output a predicted copy start position according to the top-layer hidden state, and the end point prediction head is configured to output a predicted copy end position according to the top-layer hidden state; inputting the sample source text into the initial large model, and obtaining a predicted action sequence corresponding to a predicted target text according to an output result of the initial large model; calculating a target loss function value according to the annotation action sequence and the predicted action sequence, and using the target loss function value to adjust parameters of the decision prediction head, the start point prediction head, and the end point prediction head to obtain the target large model.

That is to say, the training unit 505 obtains an initial large model by additionally adding a decision prediction head, a start point prediction head, and an end point prediction head based on an existing large model, and then adjusts parameters of three newly added prediction heads in the initial large model according to an annotation action sequence and a predicted action sequence obtained by the initial large model based on a sample source text, thereby obtaining a target large model. Since this embodiment additionally adds the three prediction heads in the large model, this embodiment integrates two operations of “generation” and “copying” within a unified, end-to-end trainable neural network framework, enabling a rapid adaptation to any existing large model with an extremely low computational cost.

In the training data obtained by the training unit 505, the sample target text corresponding to the annotation action sequence is the target text corresponding to the sample source text, for example, if the sample source text is a news article, then the sample target text is a summary corresponding to the news article.

In this embodiment, the annotation action sequence in the training data includes a plurality of annotation actions, and each annotation action includes annotation action decision information, an annotation copy start position, and an annotation copy end position, and a different annotation action corresponds to a different token (for example, a subword) in the sample target text.

In this embodiment, the predicted action sequence obtained according to an output result of the initial large model includes a plurality of predicted actions, and each predicted action includes predicted action decision information output by the decision prediction head, a predicted copy start position output by the start point prediction head, and a predicted copy end position output by the end point prediction head, and a different predicted action corresponds to a different token (for example, a subword) in the predicted target text.

In this embodiment, the predicted target text is a target text generated by the initial large model according to the input sample source text; since the initial large model in this embodiment does not modify a decoder module and a language model head, the predicted target text output by the initial large model is consistent with the sample target text corresponding to the sample source text.

Specifically, when the training unit 505 calculates the target loss function value according to the annotation action sequence and the predicted action sequence, an implementation manner that may be adopted is: according to the annotation action decision information and the predicted action decision information corresponding to a same token in the action sequence, calculating a first loss function value, and the first loss function value is used to supervise the decision prediction head; according to the annotation copy start position and the predicted copy start position corresponding to the same token in the action sequence, calculating a second loss function value, and the second loss function value is used to supervise the start point prediction head; according to the annotation copy end position and the predicted copy end position corresponding to the same token in the action sequence, calculating a third loss function value; according to the obtained first loss function value, the second loss function value, and the third loss function value, obtaining the target loss function value, for example, using a sum result of the three loss function values as the target loss function value.

That is to say, the training unit 505 obtains the target loss function value for adjusting three prediction heads according to the action decision information, the copy start position, and the copy end position included in the action sequence, and is capable of improving accuracy of the obtained target loss function value, and thereby improving accuracy when adjusting parameters of the three prediction heads.

In addition, the training unit 505 may adopt a LoRA (Low-Rank Adaptation) method to fine-tune the initial large model, i.e., freezing main parameters of the initial large model and only training three newly added prediction heads and an introduced low-rank decomposition matrix, and is capable of significantly reducing computational resources and storage costs required for fine-tuning the large model, enabling the initial large model to be trained on a consumer-grade hardware and easily applied to large language models of different scales.

When obtaining the training data, an implementation manner that may be adopted by the training unit 505 is: obtaining the sample source text and the sample target text corresponding to the sample source text, and respectively obtaining a source subword sequence of the sample source text and a target subword sequence of the sample target text; according to the source subword sequence, constructing an N-gram index corresponding to the sample source text; querying a plurality of target subwords in the target subword sequence respectively in the N-gram index, and obtaining an annotation action corresponding to each target subword according to a query result; obtaining an annotation action sequence according to annotation actions of the plurality of target subwords, and obtaining the training data according to the annotation action sequence and the sample source text.

That is to say, the training unit 505 uses an existing text pair (i.e., including a source text and its corresponding target text) to perform automatic obtaining of training data, and can automatically obtain an annotation action sequence as the training data without any manual annotation cost, improving efficiency and reducing cost of obtaining the training data.

The N-gram index corresponding to the sample source text constructed by the training unit 505 includes a plurality of source subword fragments and a start position and an end position of each source subword fragment in the sample source text.

When the training unit 505 queries the plurality of target subwords in the target subword sequence respectively in the N-gram index and obtains the annotation action corresponding to each target subword according to the query result, an implementation manner that may be adopted is: according to a current target subword, querying in the N-gram index; in response to determining that a target source subword fragment matching the current target subword is found in the N-gram index, using a copy action as annotation action decision information of the current target subword, using a start position of the target source subword fragment in the sample source text as an annotation copy start position of the current target subword, and using an end position of the target source subword fragment in the sample source text as an annotation copy end position of the current target subword.

The training unit 505 may also execute the following content: in response to determining that no target source subword fragment matching a current target subword is found in the N-gram index, using a generation action as the annotation action decision information of the current target subword.

That is to say, the training unit 505 sequentially queries target subwords in the target subword sequence in the constructed N-gram index, obtains an annotation action corresponding to each target subword in the target subword sequence according to an obtained query result, and then obtains an annotation action sequence for model training according to the obtained annotation action, and is capable of improving efficiency and reducing cost of obtaining the annotation action sequence.

In addition, the training unit 505 may, according to a target subword fragment formed by the current target subword and N−1 target subwords located after the current target subword, query in the N-gram index, and if there exists a target source subword fragment corresponding to the target subword fragment, then obtain an annotation action of the current target subword according to a “copy action” and position information corresponding to the target source subword fragment, and then perform a next query after moving forward N units in the target subword sequence.

If the training unit 505 cannot find a target source subword fragment corresponding to the target subword fragment in the N-gram index, then the training unit 505 moves forward 1 unit in the target subword sequence and continues to query a target subword located after the current target subword.

In the technical solution of the present disclosure, the acquisition, storage, and application of user personal information involved all comply with relevant laws and regulations and do not contravene public order or good morals.

According to some embodiments of the present disclosure, an electronic device, a readable storage medium, and a computer program product are also provided.

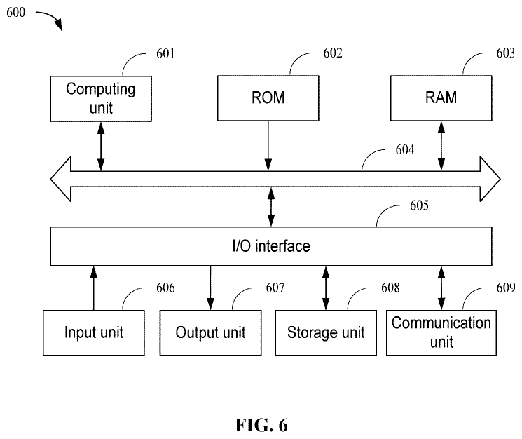

FIG. 6 is a block diagram of an electronic device for an inference acceleration method for large models according to an embodiment of the present disclosure. The electronic device is intended to represent various forms of digital computers, such as a laptop computer, a desktop computer, a workstation, a personal digital assistant, a server, a blade server, a mainframe computer, and other suitable computers. The electronic device may also represent various forms of mobile devices, such as a personal digital processing, a cellular phone, a smart phone, a wearable device, and other similar computing devices. A component shown herein, a connection and a relationship thereof, and a function thereof are merely examples and are not intended to limit an implementation of the present disclosure described and/or claimed herein.

As shown in FIG. 6, a device 600 includes a computing unit 601, which may execute various appropriate actions and processes according to a computer program stored in a read-only memory (ROM) 602 or a computer program loaded from a storage unit 608 into a random access memory (RAM) 603. In the RAM 603, various programs and data required for an operation of the device 600 may also be stored. The computing unit 601, the ROM 602, and the RAM 603 are connected to each other through a bus 604. An input/output (I/O) interface 605 is also connected to the bus 604.

A plurality of components in the device 600 are connected to the I/O interface 605, including: an input unit 606, such as a keyboard, a mouse, etc.; an output unit 607, such as various types of displays, speakers, etc.; a storage unit 608, such as a magnetic disk, an optical disk, etc.; and a communication unit 609, such as a network card, a modem, a wireless communication transceiver, etc. The communication unit 609 allows the device 600 to exchange information/data with another device through a computer network such as the Internet and/or various telecommunication networks.

The computing unit 601 may be various general and/or special processing components having processing and computing capability. Some examples of the computing unit 601 include but are not limited to a central processing unit (CPU), a graphics processing unit (GPU), various dedicated artificial intelligence (AI) computing chips, various computing units running a machine learning model algorithm, a digital signal processor (DSP), and any appropriate processor, controller, microcontroller, etc. The computing unit 601 executes the various methods and processes described above, for example, an inference acceleration method for large models. For example, in some embodiments, the inference acceleration method for large models may be implemented as a computer software program, which is tangibly contained in a machine-readable medium, such as the storage unit 608.

In some embodiments, part or all computer programs may be loaded and/or installed onto the device 600 via a ROM 602 and/or a communication unit 609. When the computer program is loaded into a RAM 603 and executed by the computing unit 601, one or more steps of an inference acceleration method for large models described above may be executed. Alternatively, in other embodiments, the computing unit 601 may be configured to execute the inference acceleration method for large models through any other appropriate means (for example, by means of a firmware).

Various implementations of the system and technology described herein may be implemented in a digital electronic circuit system, an integrated circuit system, a field programmable gate array (FPGA), an application specific integrated circuit (ASIC), an application specific standard product (ASSP), a system on chip system (SOC), a complex programmable logic device (CPLD), a computer hardware, a firmware, a software, and/or a combination thereof. These various implementations may include: an implementation in one or more computer programs, and the one or more computer programs may be executed and/or interpreted on a programmable system including at least one programmable processor, and the programmable processor may be a dedicated or a general-purpose programmable processor that may receive a data and an instruction from a storage system, at least one input device, and at least one output device, and transmit the data and the instruction to the storage system, the at least one input device, and the at least one output device.

A program code for implementing the method of the present disclosure may be written in any combination of one or more programming languages. The program code may be provided to a processor or a controller of a general-purpose computer, a special-purpose computer, or another programmable inference acceleration apparatus for large models, so that the program code, when executed by the processor or the controller, causes a function/an operation specified in a flowchart and/or a block diagram to be implemented. The program code may be executed entirely on a machine, partly on the machine, as a standalone software package partly on the machine and partly on a remote machine, or entirely on the remote machine or a server.

In a context of the present disclosure, a machine-readable medium may be a tangible medium that may contain or store programs for use by or in conjunction with an instruction execution system, an apparatus, or a device. The machine-readable medium may be a machine-readable signal medium or a machine-readable storage medium. The machine-readable medium may include but is not limited to an electronic, a magnetic, an optical, an electromagnetic, an infrared, or a semiconductor system, apparatus or device, or any suitable combination of the foregoing. More specific examples of a machine-readable storage medium would include an electrical connection based on one or more wires, a portable computer disk, a hard disk, a random access memory (RAM), a read-only memory (ROM), an erasable programmable read-only memory (EPROM or a flash memory), an optical fiber, a portable compact disk read-only memory (CD-ROM), an optical storage device, a magnetic storage device, or any suitable combination of the foregoing.

To provide an interaction with a user, a system and a technology described herein may be implemented on a computer having: a display device for displaying an information to the user (for example, a CRT (cathode ray tube) or an LCD (liquid crystal display) monitor); and a keyboard and a pointing device (for example, a mouse or a trackball) through which the user can provide an input to the computer. Other kinds of devices may also be used to provide the interaction with the user; for example, a feedback provided to the user may be any form of a sensory feedback (for example, a visual feedback, an auditory feedback, or a tactile feedback); and an input from the user may be received in any form (including an acoustic input, a speech input, or a tactile input).

A system and a technology described herein may be implemented in a computing system that includes a back-end component (for example, as a data server), or a computing system that includes a middleware component (for example, an application server), or a computing system that includes a front-end component (for example, a user computer having a graphical user interface or a web browser through which a user may interact with an implementation of the system and the technology described herein), or a computing system that includes any combination of such a back-end component, a middleware component, or a front-end component. A component of a system may be interconnected by any form or medium of a digital data communication (for example, a communication network). Examples of a communication network include: a local area network (LAN), a wide area network (WAN), and the Internet.

A computer system may include a client and a server. The client and the server are generally remote from each other and typically interact through a communication network. A relationship of the client and the server arises by virtue of a computer program running on a respective computer and having a client-server relationship to each other. The server may be a cloud server, also referred to as a cloud computing server or a cloud host, which is a host product in a cloud computing service system, solving a defect of a high management difficulty and a weak business scalability that exists in a traditional physical host and a VPS service (“Virtual Private Server”, or “VPS” for short). The server may also be a server in a distributed system, or a server combined with a blockchain.

It should be understood that various forms of a flow shown above may be used, with a step reordered, added, or deleted. For example, each step described in the present disclosure may be executed in parallel, sequentially, or in a different order, as long as a desired result of a technical solution disclosed in the present disclosure can be achieved, and no limitation is imposed herein.

The above specific implementations do not constitute a limitation on a protection scope of the present disclosure. A person skilled in the art should understand that various modifications, combinations, sub-combinations, and substitutions may be made according to a design requirement and other factors. Any modification, equivalent substitution, and improvement made within a spirit and a principle of the present disclosure should be included within the protection scope of the present disclosure.

What is claimed is:

1. An inference acceleration method for large models, comprising:
after inputting a source text to be processed into a target large model, obtaining a top-layer hidden state of the target large model for predicting a next token;
obtaining action decision information corresponding to the next token according to the top-layer hidden state;
in response to determining that the action decision information is a copy action, obtaining a text copy interval corresponding to the next token according to the top-layer hidden state; and
copying a text in the source text to be processed that is located within the text copy interval, and using a copy result as the next token.

2. The method according to claim 1, wherein obtaining the action decision information corresponding to the next token according to the top-layer hidden state comprises:
inputting the top-layer hidden state into a decision prediction head of the target large model; and
obtaining the action decision information corresponding to the next token according to an output result of the decision prediction head.

3. The method according to claim 1, wherein obtaining the text copy interval corresponding to the next token according to the top-layer hidden state in response to determining that the action decision information is the copy action comprises:
inputting the top-layer hidden state into a start point prediction head of the target large model, and obtaining a copy start position corresponding to the next token according to an output result of the start point prediction head;
inputting the top-layer hidden state into an end point prediction head of the target large model, and obtaining a copy end position corresponding to the next token according to an output result of the end point prediction head; and
obtaining the text copy interval corresponding to the next token according to the copy start position and the copy end position.

4. The method according to claim 1, further comprising:
in response to determining that the action decision information is a generation action, inputting the top-layer hidden state into a language model head of the target large model; and
obtaining the next token according to an output result of the language model head.

5. The method according to claim 1, wherein copying the text in the source text to be processed that is located within the text copy interval, and using the copy result as the next token comprises:
obtaining a subword sequence of the source text to be processed;
determining a subword in the subword sequence located within the text copy interval according to position information of each subword in the subword sequence; and
copying the determined subword, and using the copy result as the next token.

6. The method according to claim 1, further comprising:
obtaining training data, wherein the training data comprises a sample source text and an annotation action sequence corresponding to a sample target text;
constructing an initial large model comprising a decoder module, a language model head, a decision prediction head, a start point prediction head, and an end point prediction head, wherein the decision prediction head is configured to output a predicted action decision information according to a top-layer hidden state output by the decoder module, the start point prediction head is configured to output a predicted copy start position according to the top-layer hidden state, and the end point prediction head is configured to output a predicted copy end position according to the top-layer hidden state;
inputting the sample source text into the initial large model, and obtaining a predicted action sequence corresponding to a predicted target text according to an output result of the initial large model; and
calculating a target loss function value according to the annotation action sequence and the predicted action sequence, and using the target loss function value to adjust parameters of the decision prediction head, the start point prediction head, and the end point prediction head to obtain the target large model.

7. The method according to claim 6, wherein obtaining the training data comprises:
obtaining the sample source text and the sample target text corresponding to the sample source text, and respectively obtaining a source subword sequence of the sample source text and a target subword sequence of the sample target text;
constructing an N-gram index corresponding to the sample source text according to the source subword sequence;
querying a plurality of target subwords in the target subword sequence respectively in the N-gram index, and obtaining an annotation action corresponding to each target subword according to a query result; and
obtaining the annotation action sequence according to annotation actions of the plurality of target subwords, and obtaining the training data according to the annotation action sequence and the sample source text.

8. The method according to claim 7, wherein querying the plurality of target subwords in the target subword sequence respectively in the N-gram index, and obtaining the annotation action corresponding to each target subword according to the query result comprises:
querying in the N-gram index according to a current target subword; and
in response to determining that a target source subword fragment matching the current target subword is found in the N-gram index, using a copy action as annotation action decision information of the current target subword, using a start position of the target source subword fragment in the sample source text as an annotation copy start position of the current target subword, and using an end position of the target source subword fragment in the sample source text as an annotation copy end position of the current target subword.

9. The method according to claim 8, further comprising:
in response to determining that no target source subword fragment matching the current target subword is found in the N-gram index, using a generation action as annotation action decision information of the current target subword.

10. The method according to claim 6, wherein calculating the target loss function value according to the annotation action sequence and the predicted action sequence comprises:
calculating a first loss function value according to annotation action decision information and predicted action decision information corresponding to a same token in an action sequence;
calculating a second loss function value according to an annotation copy start position and a predicted copy start position corresponding to the same token in the action sequence;
calculating a third loss function value according to an annotation copy end position and a predicted copy end position corresponding to the same token in the action sequence; and
obtaining the target loss function value according to the first loss function value, the second loss function value, and the third loss function value.

11. An electronic device, comprising:
at least one processor; and
a memory communicatively connected to the at least one processor; wherein,
the memory stores instructions executable by the at least one processor to cause the at least one processor to perform an inference acceleration method for large models, comprising:
after inputting a source text to be processed into a target large model, obtaining a top-layer hidden state of the target large model for predicting a next token;
obtaining action decision information corresponding to the next token according to the top-layer hidden state;
in response to determining that the action decision information is a copy action, obtaining a text copy interval corresponding to the next token according to the top-layer hidden state; and
copying a text in the source text to be processed that is located within the text copy interval, and using a copy result as the next token.

12. The electronic device according to claim 11, wherein obtaining the action decision information corresponding to the next token according to the top-layer hidden state comprises:
inputting the top-layer hidden state into a decision prediction head of the target large model; and
obtaining the action decision information corresponding to the next token according to an output result of the decision prediction head.

13. The electronic device according to claim 11, wherein obtaining the text copy interval corresponding to the next token according to the top-layer hidden state in response to determining that the action decision information is the copy action comprises:
inputting the top-layer hidden state into a start point prediction head of the target large model, and obtaining a copy start position corresponding to the next token according to an output result of the start point prediction head;
inputting the top-layer hidden state into an end point prediction head of the target large model, and obtaining a copy end position corresponding to the next token according to an output result of the end point prediction head; and
obtaining the text copy interval corresponding to the next token according to the copy start position and the copy end position.

14. The electronic device according to claim 11, further comprising:
in response to determining that the action decision information is a generation action, inputting the top-layer hidden state into a language model head of the target large model; and
obtaining the next token according to an output result of the language model head.

15. The electronic device according to claim 11, wherein copying the text in the source text to be processed that is located within the text copy interval, and using the copy result as the next token comprises:
obtaining a subword sequence of the source text to be processed;
determining a subword in the subword sequence located within the text copy interval according to position information of each subword in the subword sequence; and
copying the determined subword, and using the copy result as the next token.

16. The electronic device according to claim 11, further comprising:
obtaining training data, wherein the training data comprises a sample source text and an annotation action sequence corresponding to a sample target text;
constructing an initial large model comprising a decoder module, a language model head, a decision prediction head, a start point prediction head, and an end point prediction head, wherein the decision prediction head is configured to output a predicted action decision information according to a top-layer hidden state output by the decoder module, the start point prediction head is configured to output a predicted copy start position according to the top-layer hidden state, and the end point prediction head is configured to output a predicted copy end position according to the top-layer hidden state;
inputting the sample source text into the initial large model, and obtaining a predicted action sequence corresponding to a predicted target text according to an output result of the initial large model; and
calculating a target loss function value according to the annotation action sequence and the predicted action sequence, and using the target loss function value to adjust parameters of the decision prediction head, the start point prediction head, and the end point prediction head to obtain the target large model.

17. The electronic device according to claim 16, wherein obtaining the training data comprises:
obtaining the sample source text and the sample target text corresponding to the sample source text, and respectively obtaining a source subword sequence of the sample source text and a target subword sequence of the sample target text;
constructing an N-gram index corresponding to the sample source text according to the source subword sequence;
querying a plurality of target subwords in the target subword sequence respectively in the N-gram index, and obtaining an annotation action corresponding to each target subword according to a query result; and
obtaining the annotation action sequence according to annotation actions of the plurality of target subwords, and obtaining the training data according to the annotation action sequence and the sample source text.

18. The electronic device according to claim 17, wherein querying the plurality of target subwords in the target subword sequence respectively in the N-gram index, and obtaining the annotation action corresponding to each target subword according to the query result comprises:
querying in the N-gram index according to a current target subword; and
in response to determining that a target source subword fragment matching the current target subword is found in the N-gram index, using a copy action as annotation action decision information of the current target subword, using a start position of the target source subword fragment in the sample source text as an annotation copy start position of the current target subword, and using an end position of the target source subword fragment in the sample source text as an annotation copy end position of the current target subword; and
in response to determining that no target source subword fragment matching the current target subword is found in the N-gram index, using a generation action as annotation action decision information of the current target subword.

19. The electronic device according to claim 16, wherein calculating the target loss function value according to the annotation action sequence and the predicted action sequence comprises:
calculating a first loss function value according to annotation action decision information and predicted action decision information corresponding to a same token in an action sequence;
calculating a second loss function value according to an annotation copy start position and a predicted copy start position corresponding to the same token in the action sequence;
calculating a third loss function value according to an annotation copy end position and a predicted copy end position corresponding to the same token in the action sequence; and
obtaining the target loss function value according to the first loss function value, the second loss function value, and the third loss function value.

20. A non-transitory computer-readable storage medium storing computer instructions for causing a computer to perform an inference acceleration method for large models, comprising:
after inputting a source text to be processed into a target large model, obtaining a top-layer hidden state of the target large model for predicting a next token;
obtaining action decision information corresponding to the next token according to the top-layer hidden state;
in response to determining that the action decision information is a copy action, obtaining a text copy interval corresponding to the next token according to the top-layer hidden state; and
copying a text in the source text to be processed that is located within the text copy interval, and using a copy result as the next token.
